(19) United States
(12) Patent Application Publication
(10) Pub. No.: US 2016/0147051 A1
(43) Pub. Date: May 26, 2016

(54) Miltonian Mirror for Oblique Catoptric Telescopes

(71) Applicant: Milton Lachman, Markham (CA)

(72) Inventor: Milton Lachman, Markham (CA)

(21) Appl. No.: 14/552,406

(22) Filed: Nov. 24, 2014

(51) Int. Cl. G02B 17/06; G02B 23/02

(52) U.S. Cl. CPC G02B 17/0647; G02B 23/02

(57) ABSTRACT

One embodiment of a front-surface mirror (100) for oblique catoptric telescopes as a means for focusing image-forming rays to its prime focus without obstruction. The embodiment provides a happy medium between two cited examples of prior art, or even an absolute advantage over both examples, in terms of light grasp, resolution, field curvature, astigmatism and coma. The embodiment is of a shape that may be derived from the division of a figured substrate for a conventional Cassegrain primary mirror into four identical quarters. The embodiment is thereby producible in conjunction with turning the front surface (22) of any such quarter into a reflective means. Other embodiments are described.

### CROSS-REFERENCE TO RELATED APPLICATION

This application for “A Miltonian Mirror for Oblique Catoptric Telescopes” claims the benefit of Provisional Patent Application Ser. No. 61/963,351 filed 30 Nov. 2013.

### BACKGROUND

1. Field of the Miltonian Mirror

In some uses, embodiments of the Miltonian mirror relate to oblique reflecting telescopes, each using a single ocular whose optical axis is normally aligned obliquely to that of its primary mirror, or coaxially in duplicative uses, whereby such a telescope could be paired with an identical twin of itself for binocular viewing; but in either case, telescopic uses are possible, which employ secondary or even tertiary mirrors that represent other uses of Miltonian mirrors.

### Foreign Patent Prior Art Documentation

| Document No | Country | Kind | Published | Patentee |
|---|---|---|---|---|
| 768402 | CA | A | 1967 Oct. 3 | A. H. Hale |
| 1104297 | GB | A | 1968 Feb. 21 | A. H. Hale |

### Non-Patent Prior Art Documentation

U. of Arizona, “UA to shape solar telescope mirror.” (23 Jun. 2011) http://m.phys.org/news/2011-06-ua-solar-telescope-mirror.html

2. Prior Art

Early examples of oblique catoptric telescopes were built in the 1700s by William Herschel using circular mirrors whose front-surface contours were both radially and azimuthally symmetric about their centres. Since then, advances in the figuring and in the coating of mirrors have led to a decrease in aberrations and to an increase in light-gathering ability, respectively, such that a radially asymmetric front surface conforming to an off-axis section of a paraboloid of revolution is preferred for such a telescope nowadays, e.g. as used for the Advanced Technology Solar Telescope in Hawaii, despite requiring more expertise and expense to asymmetrically figure such a mirror. In a single-mirror oblique telescope of the ATST's Herschellian design, a mirror with a circular perimeter is used, because such a shape maximises surface area, and thereby maximises its ability to gather light with regard to certain parameters, such as weight and contrast ratio. Nonetheless, any resulting image will suffer from a greater degree of aberration for image-forming rays emanating from the region of its reflective surface beyond 1.4 of its radii from the optical axis than from within: they likewise engender a greater degree of aberration vis-a-vis a semicircular mirror of equal focal length and equal surface area. Consequently, its advantage in light-gathering ability is inadequate compensation for other applications. Arthur H. Hale's Improved Reflecting Telescope as disclosed in U.K. patent GB1104297(A) (1968), which is identical to his Canadian patent CA768402(A) (1967), uses semicircular primary mirrors that concentrate reflective area within 1.4 of said radii from the optical axis, by vertically bisecting a Newtonian primary mirror having the same focal length and twice the reflective surface area as a circular mirror for a Herschellian telescope, thereby creating an identical pair of mirror segments, whereby each will have the same reflective surface area and focal length as the circular mirror. Yet in removing some sources of aberration, Hale's design creates others related to image-forming rays emanating from the regions along the linear boundaries of the reflective surface.

### SUMMARY

In accordance with some embodiments for obliquely viewing with an eyepiece an image formed at a prime focus, exemplars of the Miltonian mirror are the conceptual equivalents of the result of dividing symmetric telescopic primary mirrors into four equal quarters.

### Advantages

The Miltonian mirror allows optical technicians having ordinary budgets and skill in the art of making telescopic mirrors to achieve a happy medium between both foregoing examples of prior art for oblique telescopes, or even a general improvement over both as well as over a primary mirror for a Newtonian telescope:
A. a gain in light-gathering power of ˜15% compared to a Herschellian mirror using a conventional mirror cell in a square tube identical in size to one whose inside width equals that of each straight edge of the Miltonian mirror with regard to some embodiments
B. with regard to some embodiments, three intrinsic catoptric aberrations are mitigated compared to Hale's primary mirrors:
   1. coma
   2. astigmatism on the optimal image surface
   3. field curvature of the optimal image surface
C. with regard to some embodiments in comparison to primary mirrors for the foregoing prior art as well as Newtonians, there is:
   1. slightly improved limiting resolution in general, or as measured by the Rayleigh Limit, ˜15% greater resolving power
   2. improved resolution of unequal double stars in general when the much fainter companion is at the inside edge of the first bright ring around the brighter principal star
D. with regard to some embodiments in comparison to primary mirrors for Newtonians, there is:
   1. ˜1.5 times the contrast ratio when the nominal obscuration ratio is the same as the actual obscuration ratio for a Newtonian; or
   2. about the same contrast ratio when the nominal obscuration ratio is 1.5 times the actual obscuration ratio for a Newtonian.

### DRAWINGS

### Figures

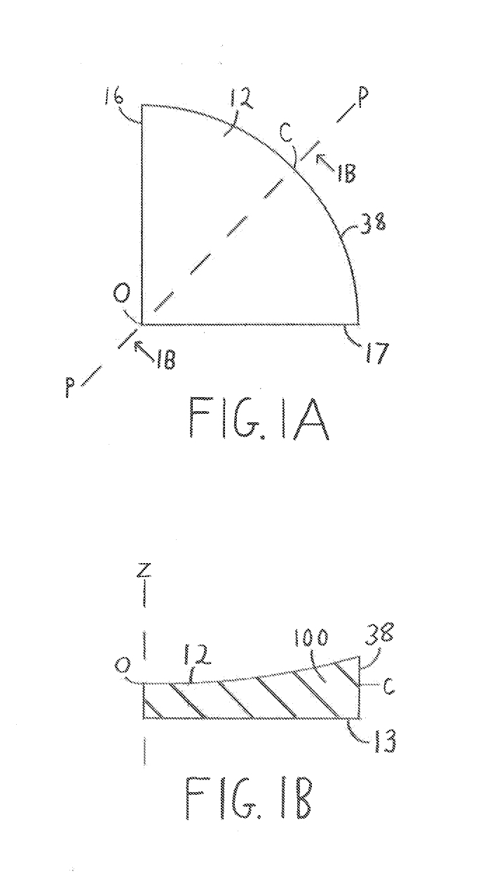

FIG. 1A shows an overhead view of an embodiment conceptually equivalent to a quarter of a Newtonian primary

FIG. 1B shows a diagonal cross-sectional view of the embodiment of FIG. 1A

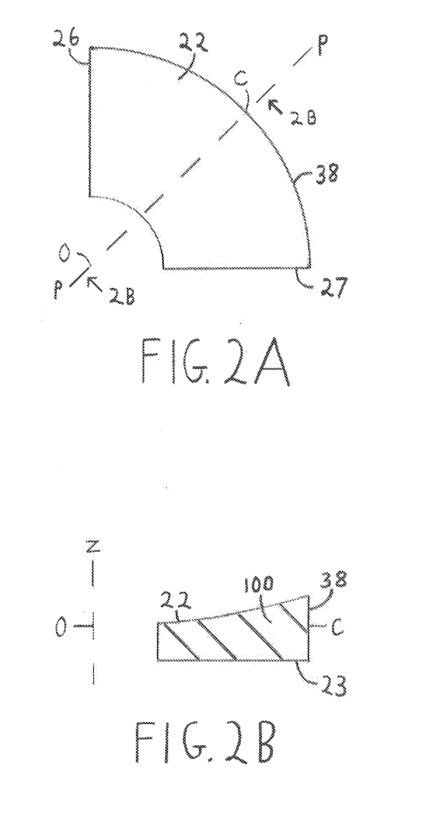

FIG. 2A shows an overhead view of an embodiment conceptually equivalent to a quarter of a conventional Cassegrain primary

FIG. 2B shows a diagonal cross-sectional view of the embodiment of FIG. 2A

### REFERENCE NUMERALS

12 front surface conforming to a paraboloid: curvature exaggerated
13 back surface conforming to a plane
16 boundary along y-z plane
17 boundary along x-z plane
22 truncated front surface conforming to a paraboloid: curvature exaggerated
23 truncated back surface conforming to a plane
26 truncated boundary along y-z plane
27 truncated boundary along x-z plane
28 truncation boundary around optical axis z
38 outer perimeter
100 mirror in cross-section along diagonal plane P vertically bisecting it

### DETAILED DESCRIPTION

### Of Embodiments Shown in all Figures

In accordance with at least one embodiment, the Miltonian mirror comprises a mirror 100 whose front surface, 12 or 22, has a concave shape that essentially conforms to an off-axis subsection of a paraboloid of revolution, wherein the axis of revolution determines an optical axis z, along which origin O is the vertex of the paraboloid. Prime focus F of the mirror thereby coincides with the focus of the paraboloid, so that each focus is at a distance L from origin O. L is thereby the focal length of the device. Its back surface, 23 or 13, may have any form suitable for the mounting in which the mirror is to be set, such as: a constant depth H below a cartesian x-y plane, Q, perpendicular to z; or a variable depth h(r) that varies with the radial distance r from z, whereby h(r) is the corresponding function of r.

Mirror 100 is designed to fit into an essentially square rectangle q in the x-y plane, such that each side of q has a width approximately equal to W. One of q's corner-points coincides with origin O, through which the optical axis z perpendicularly intersects Q. The point on q's opposite corner from O determines point I, the straight line from O to I determines diagonal p, and the plane which contains z and p determines plane P.

### Of Embodiment Shown in FIG. 1A & FIG. 1B

The first embodiment shown appears in FIG. 1B (bilaterally symmetric cross-section), as well as in FIG. 1A (top view) in which is shown: two straight boundaries, 16 along the y-z plane, and 17 along the x-z plane, that are aligned with two adjacent sides of q, so that each has an approximate length of W from z, where the near end of each boundary connects; an outer perimeter 38 whose perpendicular projection onto Q conforms to a segment A of a circle at a distance R from z, from the far end of 16, and to the far end of 17; and a centre-point C along segment A determined by the intersection of p and A. FIG. 1B shows a constant sub-Q depth H being to scale at circa R/6, but an exaggerated curvature for front surface 12.

### Of Embodiment Shown in FIG. 2A & FIG. 2B

The second embodiment shown appears in FIG. 2A (top view) and FIG. 2B (bilaterally symmetric cross-section), such that it has: its sub-Q depth H being circa R/6; a concave front surface 22; and a truncation 28 around the optical axis, thereby creating boundaries, 26 and 27, as if segments of 16 and of 17, respectively, and connecting the near ends of 26 and 27. The projection of truncation 28 onto Q conforms to a segment @ of a circle of radius R″ significantly less than R from z. Accordingly, @ subtends an angle of approximately 90 degrees between the near ends of boundaries 26 and 27, each of which is circa R″ from O. Just as for the first embodiment shown, it has an identical outer perimeter 38.

### Operation of Embodiment Shown in FIG. 2A & FIG. 2B

The following specifications are only for the purpose of demonstrating one example of the implementation of the second embodiment shown, whereby it exactly fits a square tube whose walls have an inside width of 184 mm that is also defined to be width W (within which there could just fit in its stead a 164 mm asymmetric Herschellian mirror mounted in a conventional mirror cell at the end near origin O). R is thereby 184 mm. R″ is circa 0.3*R at 55 mm, focal length L to be 736 mm, and depth H to be 31 mm, whereby the length of boundaries 26 and 27 is 129 mm each. R is also taken to be its nominal diameter in order to apply formulas for a nominally equivalent Newtonian mirror, so making 0.3 its nominal obscuration ratio, and 4 its equivalent f/No. The latter is constant throughout—a surprising result, given that Canadian patent CA768402(A) (1967) and U.K. patent GB1104297(A) (1968), both to Hale, use a semicircle-shaped primary having more than one effective f/No: for said primary's azimuthal midway-angle, the equivalent f/No is twice that for the two azimuthal extremes which define a boundary plane serving as a tangential plane for incident light at either of said extremes. 248 mm is said semicircle's diameter for yielding a surface area about equal to that of said example, and 124 mm the effective diameter in the perpendicular plane. Opposing contributions to a tangential image surface from said boundary plane result in a comatic wavefront error inversely proportional to the cube of the f/No for a given field height, i.e., eight times larger from said boundary plane than from the perpendicular plane, assuming no tilt of the focusing unit.

### Advantages

No such effect occurs in the operation of embodiments shown of the Miltonian mirror, because none of them has such opposing contributions along such a boundary plane, and an eyepiece viewing an image at prime focus F can be tilted along plane P obliquely away from the optical axis, such that coma is halved along P as a tangential plane. As also in the case for P as a sagittal plane, there is a median plane, midway between P and its perpendicular plane, that includes one of said adjacent sides of q, and another such median plane that includes the other adjacent side, so that photons incident upon radial sections next to either linear boundary 26 or 27, such that they are reflected along their corresponding median plane, are focused close to a median image surface between the tangential and sagittal image surfaces. Furthermore, their optimal astigmatic foci occur within smaller Least Circles of Confusion on an optimal image surface closer to the sagittal image surface for large field angles, and much closer to approximating a plane for all field angles vis-a-vis said prior art. Three intrinsic catoptric aberrations are therefore surprisingly mitigated for an image at the optimal focal surface on which F lies.

A gain in light-gathering power may be had by using, either directly or indirectly, the square tube's walls, whose inside width equals the width W of q, to help keep the Miltonian mirror aligned, so that a conventional mirror cell is unnecessary, thereby allowing a larger mirror 100 to be used in a given square q. In such a case, the example given of the second embodiment shown will accordingly result in about 15% greater light grasp than would said Herschellian mirror. The square tube will also weigh less than a like rectangular tube for Hale's semicircle-shaped primary mirror.

The Miltonian mirror will produce diffraction spikes that have about half the intensity of those produced by a four-vane secondary support for the nominally equivalent Newtonian primary mirror, from which an eyepiece will capture rays diffracted off from both sides of any given vane, so producing spikes of twice the intensity, as if the Newtonian primary had been divided into quarters—each having a pair of linear boundaries, b″ and B″, whereby each linear boundary is separated from its identical twin in the adjacent quarter by the width of the vane. An eyepiece used to view an image at F therefore captures about half the rays diffracted from each of its linear boundaries to the side in the direction of point C, when the focusing unit is slightly shifted towards the diagonal corner from F, and tilted away from O, so as to point roughly halfway-between O and C. An oblique telescope using the Miltonian mirror thereby suffers half the loss of contrast due to diffraction spikes in comparison to the equivalent Newtonian, which constitutes another surprising result. A relatively shorter curved outer perimeter 38 causes fewer photons to be diffracted into the first ring around an Airy disc, thereby resulting in a different kind of gain in contrast. Accompanying these gains are slightly improved resolution in general with the former gain, and with the latter gain, greatly improved resolution of unequal double stars, when the much fainter companion is at the inside edge of the first bright ring around the brighter principal star. As measured by the Rayleigh Limit, the second embodiment shown delivers 15% greater resolving power vis-a-vis said semicircle-shaped primary mirror.

No embodiment of the Miltonian mirror curtails a square tube of an absolute advantage possessed by it over a cylindrical tube: namely, to allow for, along its edge opposite from that along z, a small right-angle finder into which a removable eyepiece may be inserted though a hole in said tube. Thus, no eyepiece of the finder need extend beyond the walls of its tube during transport, for which the finder's eyepiece will likely need to be removed. This minimises the potential for damage during transport of said tube—in stark contrast to designs using cylindrical tubes.

### Exemplary Methods of Making Embodiments Shown

One method of making the first embodiment shown is by quartering along the x-z and the y-z planes a figured glass substrate for a 368 mm Newtonian primary mirror whose focal length is 736 mm, and by afterwards overlaying the front surface of any such quarter with a reflective material, which in turn may optionally be overlaid with a coating or coatings to improve reflectivity within a related spectral window.

If a figured glass substrate for a traditional Cassegrain primary of like diameter and focal length is instead quartered to make the second embodiment shown of the Miltonian mirror, a gain in terms of manufacturing productivity may be had. Quartering such substrate as the second embodiment can also result in less waste, if a localised surface defect were to make the primary as a whole unusable in a Cassegrain telescope. Even less glass will be used, if, to likewise make yet another embodiment (not shown), one quarters a figured glass substrate as used for the primaries of most commercially manufactured catadioptric telescopes, for which back surface in part typically conforms to a coaxial cone beyond a certain radius R′, within which there is a circular perforation at a smaller radius R″. It is to undergo additional figuring prior to quartering, if its front surface has a shape that conforms to something other than a paraboloid, such as a sphere in the case of quartering the figured glass substrates for Maksutov primary mirrors. Afterwards, the front surface of any such quarter is to be overlaid with a reflective material, which in turn may optionally be overlaid with a coating or coatings to improve reflectivity within a related spectral window.

### Further Exemplary Uses

As one alternative use of the second embodiment shown, a secondary mirror can be placed between its prime focus F and front surface 32 to reflect its image-forming rays of light via an optical flat perpendicular to z to a focus f along z in front of origin O (where could be placed: an image inverter to form an image behind O along z, or an image at a Nasmyth focus via a tertiary mirror). Further examples of such uses may be had by placing: a convex hyperboloidal secondary mirror between the second embodiment shown and F to reflect the rays to a Cassegrain focus behind O along z; or a concave ellipsoidal secondary beyond F to reflect the rays to a Gregorian focus behind O along z.

An example of an alternate use to which any paraboloidal embodiment of the Miltonian mirror is well-suited, is that of placing an optical flat between it and F, whereby it reflects image-forming rays (e.g., when reflecting light from a nighttime star nominally located at infinity along z) via the optical flat to a Newtonian focus at the square tube's edge opposite from that along z.

### CONCLUSION, RAMIFICATIONS, SCOPE

Although the description above contains many specificities, these should not be construed as limits on the scope of the Miltonian mirror, but as mere illustrations of disparate examples of embodiments as well as uses. Many other ramifications and variations are possible within the exemplifications of various embodiments: dimensions and parameters may vary in accordance with design objectives; the material of the substrate can be of a material other than glass; rather than perpendicular to plane Q, each or any edge of mirror 100 may be oblique or beveled, or rounded, or any combination thereof; the back surface 23 can have shapes other than flat; front surface 32 can be flat, or can be convex instead of concave, and may assume the shape of a conic section of revolution other than that of a paraboloid; truncation 28 may have as its projection another form, such as oval, elliptical, linear, wavy, a quartered hexagon, etc.

Other embodiments accordingly are producible by quartering:
unperforated primaries;
secondaries as for said examples of alternative uses;
hyperboloidal, ellipsoidal, paraboloidal or spherical convex mirrors;
hyperboloidal, ellipsoidal, paraboloidal or spherical concave mirrors; or by using other methods of manufacture, such as the spin-casting method used to make the Advanced Solar Technology Telescope.

Other uses accordingly include using an embodiment of the Miltonian mirror as a tertiary mirror, or in other words, as a secondary mirror in relation to another secondary mirror. This may in turn be extended to its use as a secondary mirror in relation to a tertiary mirror, and so on.

Thus, the scope of the Miltonian mirror should be determined by the appended claims and their legal equivalents, rather than by the examples given.

I, Milton, claim:

1. An optical device comprising a front-surface mirror wherein the front surface is practically congruent to one quarter of a subsection of a paraboloid generated by the rotation of a parabola about the z axis of a three-dimensional cartesian co-ordinate system having:
(a) its z axis coincident with the parabola's axis of bilateral symmetry and thereby with said mirror's optical axis;
(b) its origin at the paraboloid's vertex along the z axis;
(c) its x-y plane and a plane approximately parallel to said x-y plane as transverse boundaries by which the subsection is determined; and
(d) its x-z plane and its y-z plane as azimuthal boundaries by which said quarter is determined;
whereby three intrinsic catoptric aberrations are mitigated for an image at the optimal focal surface of the optical device vis-a-vis an embodiment of a mirror for a prior art device, whose front surface is to have congruence with a halved subsection of said paraboloid, and to have the same surface area.

2. The optical device of claim 1, further including about said optical axis a truncation selected from the group consisting of:
a. truncations at a radius of length r from the z axis;
b. truncations by a plane that intersect the x axis and the y axis at about a distance d from the origin, and that is parallel to the z axis; and
c. truncations having a shape in-between that of truncation a and that of truncation b wherein said d is less than said r.

3. An optical device comprising a front-surface mirror wherein the front surface is practically congruent to one quarter of a subsection of another surface generated by the rotation of a conic section rotated about the z axis of a three-dimensional cartesian co-ordinate system having:
(a) its z axis coincident with the conic section's major axis and thereby with said mirror's optical axis;
(b) its origin at a vertex of the conic section along the z axis;
(c) its x-y plane and a plane approximately parallel to said x-y plane as transverse boundaries by which the subsection is determined; and
(d) its x-z plane and its y-z plane as azimuthal boundaries by which said quarter is determined.

4. The optical device of claim 3, further including about said optical axis a truncation selected from the group consisting of:
a. truncations at a radius of length r from the z axis;
b. truncations by a plane that intersect the x axis and the y axis at about a distance d from the origin, and that is parallel to the z axis; and
c. truncations having a shape in-between that of truncation a and that of truncation b wherein said d is less than said r.

5. A mirror comprising a reflecting means which is a bisected half of a segmented reflecting means, wherein the segmented reflecting means is a segment of a full reflecting means in a reflecting telescope selected from the group consisting of:
a. folded-path refracting telescopes that use optical flats as a means of folding the optical path;
b. Maksutov telescopes;
c. Cassegrain telescopes;
d. Dall-Kirkham telescopes;
e. Ritchey-Chretien telescopes;
f. Newtonian telescopes;
g. Gregorian telescopes; and
h. Herschellian telescopes;
whereby it has two straight edges that meet at a corner and contiguously fit into an essentially square tube, so that it provides greater light grasp than if another full reflecting means were to be conventionally remounted in said tube after having been taken from any of said telescopes' cylindrical tubes having an inside diameter equal to said tube's inside width.

6. The optical device of claim 5, further including about said corner a truncation selected from the group of subgroups consisting of:
a. convexly arcuate truncations;
b. linear truncations; and
c. truncations lying in-between one from subgroup a and another one from subgroup b, wherein neither one intersects the other one.

7. The optical device of claim 2 that is used as a co-operating optical device selected from the group of optical devices consisting of:
a. primary mirrors;
b. secondary mirrors; and
c. tertiary mirrors.

8. The optical device of claim 3 that is used as a co-operating optical device selected from the group of optical devices consisting of:
a. primary mirrors;
b. secondary mirrors; and
c. tertiary mirrors.

9. The optical device of claim 4 that is used as a co-operating optical device selected from the group of optical devices consisting of:
a. primary mirrors;
b. secondary mirrors; and
c. tertiary mirrors.

10. The optical device of claim 5 that is used as a co-operating optical device selected from the group of optical devices consisting of:
a. primary mirrors;
b. secondary mirrors; and
c. tertiary mirrors.

11. The optical device of claim 1 that is used as a co-operating optical device selected from the group of optical devices consisting of:
a. primary mirrors;
b. secondary mirrors; and
c. tertiary mirrors.

12. The optical device of claim 6 that is used as a co-operating optical device selected from the group of optical devices consisting of:
a. primary mirrors;
b. secondary mirrors; and
c. tertiary mirrors.
